(19) United States
(12) Patent Application Publication
(10) Pub. No.: US 2023/0266972 A1
(43) Pub. Date: Aug. 24, 2023

(54) SYSTEM AND METHODS FOR SINGLE INSTRUCTION MULTIPLE REQUEST PROCESSING

(71) Applicant: Purdue Research Foundation, West Lafayette, IN (US)

(72) Inventors: Timothy Glenn Rogers, West Lafayette, IN (US); Mahmoud Khairy, West Lafayette, IN (US)

(73) Assignee: Purdue Research Foundation, West Lafayette, IN (US)

(21) Appl. No.: 18/072,492

(22) Filed: Nov. 30, 2022

Related U.S. Application Data
(60) Provisional application No. 63/307,853, filed on Feb. 8, 2022.
(60) Provisional application No. 63/399,281, filed on Aug. 19, 2022.

(51) Int. Cl. G06F 9/38; G06F 9/48; G06F 9/30

(52) U.S. Cl. CPC G06F 9/3851; G06F 9/3842; G06F 9/4881; G06F 9/30087

(57) ABSTRACT

A system may include a central processing unit (CPU) having a Simultaneous Multi-Threading (SMT) thread/execution model. The system may further include a request processing unit (RPU) having an Out-of-Order Single Instruction Multiple Thread (SIMT) execution model. The CPU may receive a plurality of requests. The CPU may group a portion of the requests in a batch. The CPU may cause the RPU to execute instructions corresponding to each request in the batch. The RPU may execute, with a plurality of threads, the instructions corresponding to the batch of requests in lockstep.

### CROSS REFERENCE TO RELATED APPLICATIONS

This application claims the benefit of U.S. Provisional Application No. 63/307,853 filed Feb. 8, 2022 and U.S. Provisional Application No. 63/399,281 filed Aug. 19, 2022, the entirety of each of these applications is hereby incorporated by reference.

### GOVERNMENT RIGHTS

This invention was made with government support under CCF1910924 awarded by the National Science Foundation. The government has certain rights in the invention.

### TECHNICAL FIELD

This disclosure is related to micro architecture, and in particular, to multi-core micro architecture.

### BACKGROUND

Contemporary data center servers process thousands of similar, independent requests per minute. In the interest of programmer productivity and ease of scaling, workloads in data centers have shifted from single monolithic processes on each node toward a micro and nanoservice software architecture. As a result, single servers are now packed with many threads executing the same, relatively small task on different data.

State-of-the-art data centers run these microservices on multi-core CPUs. However, the flexibility offered by traditional CPUs comes at an energy-efficiency cost. The Multiple Instruction Multiple Data execution model misses opportunities to aggregate the similarity in contemporary microservices. We observe that the Single Instruction Multiple Thread execution model, employed by GPUs, provides better thread scaling and has the potential to reduce frontend and memory system energy consumption. However, contemporary GPUs are ill-suited for the latency-sensitive microservice space.

### BRIEF DESCRIPTION OF THE DRAWINGS

The embodiments may be better understood with reference to the drawings and description in the Appendix attached hereto. The components in the figures are not necessarily to scale.

FIG. 1 illustrates an example of a Single Instruction Multiple Request (SIMR) processing system.

FIG. 2 illustrates a detailed view of request processing unit (RPU) hardware.

FIG. 3 illustrates an example of MinPC policy analysis and how the PC selection interacts with divergent control flow.

FIGS. 4A-B illustrates an example of sub-batch interleaving and memory coalescing using an MCU to improve latency hiding and memory throughput efficiency respectively.

FIG. 5 illustrates an example of a LD/ST unit.

FIG. 6 illustrates dynamic energy consumption breakdown per pipeline stage as a percentage of total CPU core energy according to various embodiments and experimentation.

FIG. 7 illustrates an example of SIMT control flow efficiency with different request batching policies (Batch Size = 32).

FIG. 8 illustrates a comparison of an RPU’s software stack to that of a CPU and a GPU.

FIG. 9 illustrates an example of how an RPU driver and TLB hardware allocate and map stack memory from different threads in the same batch to minimize memory divergence.

FIG. 10 illustrates an example of stack interleaving and heap memory coalescing policy effectiveness.

FIG. 11 illustrates an example of an L1 MPKI of a single threaded CPU with 64 KB of L1 cache and an RPU with different batch sizes (32, 16, 8, 4) and 256 KB of L1 cache.

FIGS. 12A-B illustrates a frequent code pattern for a microservice and default behavior of the default C++ SlMR-agnostic CPU allocator

FIG. 13 illustrates an code example and batch split diagram for control flow divergence.

FIG. 14 illustrates an example of a end-to-end experimental setup according to various embodiments and experimentation described herein.

FIG. 15 illustrates an example of RPU and CPU-SMT8 energy efficiency (Requests/Joule) relative to single threaded CPU (higher is better).

FIG. 16 illustrates an example of RPU and CPU-SMT8 service latency relative to single threaded CPU (lower is better).

FIG. 17 illustrates several metrics that exemplify the relatively little increase in service latency for the RPU.

FIG. 18 illustrates end-to-end tail and average latency for CPU-based system vs RPU-based system with and without batch split.

FIG. 19 illustrates an example of a potential binary transformation of a scalar binary to a vector version.

### DETAILED DESCRIPTION

The written description in the appendix attached hereto is hereby incorporated by reference in its entirety. While various embodiments have been described, it will be apparent to those of ordinary skill in the art that many more embodiments and implementations are possible. Accordingly, the embodiments described herein are examples, not the only possible embodiments and implementations.

The growth of hyperscale data centers has steadily increased in the last decade, and is expected to continue in the coming era of Artificial Intelligence and the Internet of Things. However, the slowing of Moore’s Law has resulted in energy, environmental and supply chain issues that has lead data centers to embrace custom hardware/software solutions.

While improving Deep Learning (DL) inference has received significant attention, general purpose compute units are still the main driver of a data center’s total cost of ownership (TCO). CPUs consume 60% of the data center power budget, half of which comes from the pipeline’s frontend (i.e. fetch, decode, branch prediction (BP), and Out-of-Order (OoO) structures). Therefore; 30% of the data-center’s total energy is spent on CPU instruction supply.

Coupled with the hardware efficiency crisis is an increased desire for programmer productivity, flexible scalability and nimble software updates that has lead to the rise of software microservices. Monolithic server software has been largely replaced with a collection of micro and nanoservices that interact via the network. Compared to monolithic services, microservices spend much more time in network processing, have a smaller instruction and data footprint, and can suffer from excessive context switching due to frequent network blocking.

To meet both latency and throughput demands, contemporary data centers typically run microservices on multicore, OoO CPUs with and without Simultaneous Multithreading (SMT). Previous academic and industrial work has shown that current CPUs are inefficient in the data center as many on-chip resources are underutilized or ineffective. To make better use of these resource, on-chip throughput is increased, by adding more cores and raising the SMT degree. On the low-latency end are OoO Multiple Instruction Multiple Data (MIMD) CPUs with a low SMT-degree. Different CPU designs trade-off single thread latency for energy-efficiency by increasing the SMT-degree and moving from OoO to in-order execution. On the high-efficiency end are in-order Single Instruction Multiple Thread (SIMT) GPUs that support thousands of scalar threads per core. Fundamentally, GPU cores are designed to support workloads where single-threaded performance can be sacrificed for multi-threaded throughput. However, we argue that the energy-efficient nature of the GPU’s execution model and scalable memory system can be leveraged by low-latency OoO cores, provided the workload performs efficiently under SIMT execution. SIMT machines aggregate scalar threads into vector-like instructions for execution (i.e. a warp). To achieve high energy-efficiency, the threads aggregated into each warp must traverse similar control-flow paths, otherwise lanes in the vector units must be masked off (decreasing SlMT-efficiency) and the benefits of aggregation disappear.

We make the observation that contemporary microservices exhibit a SIMT-friendly execution pattern. Data center nodes running the same microservice across multiple requests create a natural batching opportunity for SIMT hardware, if service latencies can be met. Contemporary GPUs are ill-suited for this task, as they forego single threaded optimizations (OoO, speculative execution, etc.) in favor of excessive multithreading. Prior work on directly using GPU hardware to execute data center applications reports up to 6000x higher latency than the CPU. Furthermore, accessing I/O resources on GPUs requires CPU co-ordination and GPUs do not support the rich set of programming languages represented in contemporary microservices, hindering programming productivity.

With the introduction of SlMT-on-SlMD compiler, like Intel ISPC, running SIMT-friendly microservice workloads on CPU’s SIMD is also possible. By assigning each request to a SIMD lane and executing them in a SIMD fashion, high energy efficiency can be achieved while still leveraging some latency optimizations of the CPU pipeline. However, running coarse-grain microservice threads on a fine-grain SIMD lane context, relying heavily on mask predicates to handle branches, and a limited number of SIMD units per CPU core will all lead to increasing service latency compared to CPU’s single-thread performance. Further, this method requires a complete recompilation of the microservice code and ISA extension for the missing scalar instructions that have no 1:1 mapping (see Section IV-A for further details).

SIMT-on-SIMD compilers, like Intel ISPC [42], provide a potential path to run SIMT-friendly microservices on CPU SIMD units. This method has the potential to achieve high energy efficiency while leveraging some of the CPU pipeline’s latency optimizations by assigning each thread to a SIMD lane. However, this approach has several drawbacks. First, each microservice thread requires more register file and cache capacity than work typically assigned to a single fine-grained SIMD lane, negatively impacting service latency. Second, this approach transforms conditional scalar branches into predicates, limiting the benefit of the CPU’s branch predictor. Finally, this method requires a complete recompilation of the microservice code and new ISA extensions for the scalar instructions with no 1:1 mapping in the vector ISA (see Section VI-A for further details)..

To this end, we propose replacing the CPUs in contemporary data centers with a general-purpose architecture customized for microservices: the Request Processing Unit (RPU). The RPU improves the energy-efficiency of contemporary CPUs by leveraging the frontend and memory system design of SIMT processors, while meeting the single thread latency and programmability requirements of microservices by maintaining OoO execution and support for the CPU’s ISA and software stack. Under ideal SIMT-efficiency conditions, the RPU improves energy-efficiency in three ways. First, the 30% of total data center energy spent on CPU instruction supply can be reduced by the width of the SIMT unit (up to 32 in our proposal). Second, SIMT pipelines make use of vector register files and SIMD execution units, saving area and energy versus a MIMD pipeline of equivalent throughput. Finally, SIMT memory coalescing aggregates access among threads in the same warp, producing up to 32x fewer memory system accesses. Although the cache hit rate for SMT CPUs may be high when concurrent threads access similar code/data, bandwidth and energy demands on both cache and OoO structures will be higher than an OoO SIMT core where threads are aggregated.

Moving from a scalar MIMD pipeline to a vector-like SIMT pipeline has a latency cost. To meet timing constraints, the clock and/or pipeline depth of the SIMT execution units must be longer than that of a MIMD core with fewer threads. However, the SIMT core’s memory coalescing capabilities help offset this increase in latency by reducing the bandwidth demand on the memory system, decreasing the queueing delay experienced by individual threads. In our evaluation, we faithfully model the RPU’s increased pipeline latency (Section II) and demonstrate that despite a pessimistic assumption that the ALU pipeline 4x deeper in the RPU and that L1 hit latency is > 2x higher, the average service latency is only 33% higher than a MIMD CPU chip.

The system and methods described herein provide various technical advancements including, without limitation, 1) The system and methods describe herein provide the first SIMT-efficiency characterization of microservices using their native CPU binaries. This work demonstrates that, given the right batching mechanisms, microservices execute efficiently on SIMT hardware. 2) The system and methods describes herein provide a new hardware architecture, the Request Processing Unit (RPU). The RPU improves the energy-efficiency and thread-density of contemporary OoO CPU cores by exploiting the similarity between concurrent microservice requests. With a high SIMT efficiency, the RPU captures the single threaded advantages of OoO CPUs, while increasing Requests/Joule. 3) The system and methods here provide a novel software stack, co-designed with the RPU hardware that introduces SIMR-aware mechanisms to compose/split batches, tune SIMT width, and allocate memory to maximize coalescing. 4) On a diverse set of 13 CPU microservices, the system and methods described herein demonstrate that the RPU improves Requests/Joule by an average of 5.6x versus OoO single threaded and SMT CPU cores, while maintaining acceptable end-to-end latency. Additional and alternative technical advancements are made evident in the detailed description included herein.

### I. Single Instruction Multiple Request (SIMR) System

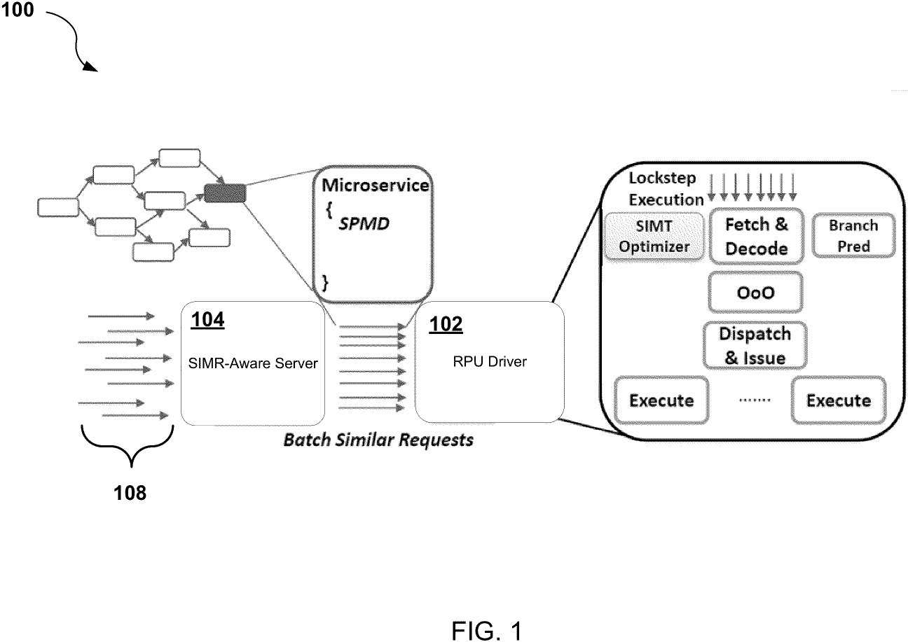

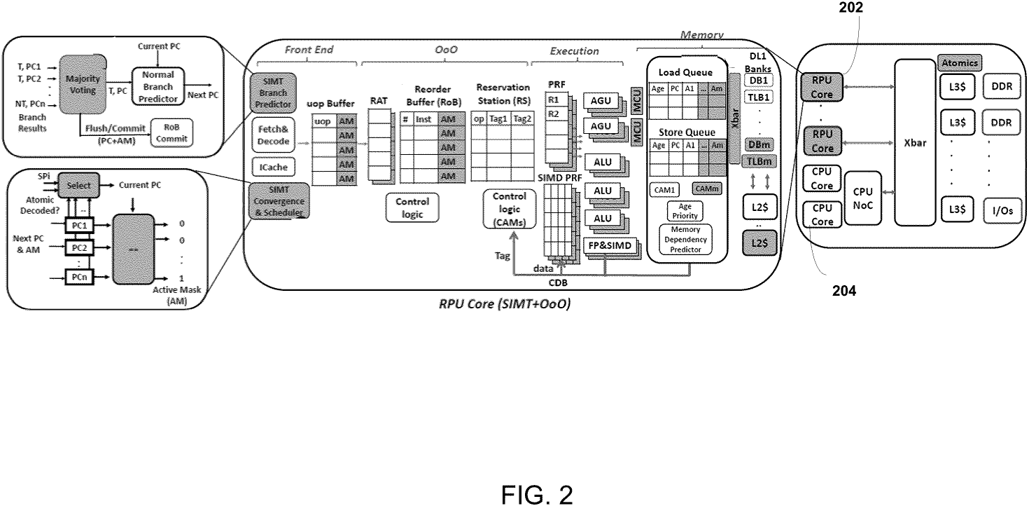

FIG. 1 illustrates an example of a Single Instruction Multiple Request (SIMR) processing system 100. The system 100 may include an request processing unit (RPU) driver 102. The RPU driver 102 facilitate execution of an RPU (see FIG. 2) which may execute instructions according to a general-purpose CPU ISA, supporting all the same functionality as a typical CPU core, but aggregates the use of all its frontend structures over multiple threads. Table 1 contrasts CPUs, GPUs and the RPU at a high level.

TABLE 1

CPU vs RPU vs GPU Key Metrics

| | | | |
|---|---|---|---|
| Metric | CPU | GPU | RPU |
| Thread/Execution Model | SMT | SIMT | SIMT |
| General Purpose Programming | Y | N | Y |
| System Calls Support | Y | N | Y |
| Service Latency | Y | N | Y |
| Energy Efficiency (Requests / Joule) | N | Y | Y |

The system may further include a SIMR-Aware Server 104. The SIMR-aware server 104 may include a server which identifies HTTP requests, RPC request, and/or requests of other communications protocols which are configured for microservices (or other hosted endpoints). To maintain end-to-end latency requirements and keep throughput high, the SIMR-Aware Server 104 may perform batching to increase SIMT efficiency, hardware resource tuning to reduce cache and memory contention, SIMR-aware memory allocation to maximize coalescing opportunities, and a system-wide batch split mechanism to minimize latency when requests traverse divergent paths with drastically different latencies.

At runtime, a SIMR-aware server 104 may group similar requests into batches. By way of example, Remote Procedure Call (RPC) or HTTP requests 108 are received or identified by the SIMR-Aware server 106. It should be appreciated that requests over other communications protocols are also possible. The SIMR-Aware server 106 groups requests into a batch based on each request’s Application Program Interface (API), the invoked procedure or endpoint, similarity of arguments, the number of arguments, and/or other attributes. The batches in the RPU are analogous to warps in a GPU. The batch size is tunable based on resource contention, desired QoS, arrival rate and system configuration (Section I-B below explores these parameters). Then, the server launches a service request to the RPU driver and hardware. The RPU 102 causes the RPU hardware to execute the batch in lock-step fashion over the OoO SIMT pipeline (Section l-A).

### A. RPU Hardware

FIG. 2 illustrates a detailed view request processing unit (RPU) hardware. The RPU hardware may include a chip which includes one or more RPU cores 202, and a one or more CPU cores 204. In preferred deployments, there may be more RPU cores than CPU cores. The role of the CPU cores is to run OS process, the SIMR server, and RPU driver while the RPU cores run the microservices requests’ workload. Each RPU core is similar to a brawny OoO CPU core, except hardware is added (shaded) to perform multithreading in a SIMT fashion.

The design philosophy of the RPU is that the area/power savings gained by SIMT execution and amortizing front-end (e.g., OoO control logic, branch predictor, fetch&decode), are used to increase the thread context and throughput at the backend (e.g., scalar/SIMD physical register file (PRF), execution units, and cache resources); thus we still maintain the same area/power budget and improve overall throughput/watt. It is worth noting that the RPU thread has the same coarse granularity as the CPU thread, such that the RPU thread has a similar thread context of integer and SIMD register file space. In addition, all execution units, including the SIMD engines, are increased by the number of SIMT lanes.

OoO SIMT Pipeline: When merging the RPU’s SIMT pipeline with speculative, OoO execution, following design principles were contemplated. First, the active mask (AM) is propagated with the instruction throughout the entire pipeline. Therefore, register alias table (RAT), instruction buffer and reorder buffer entries are extended to include the active mask (AM). Second, to handle register renaming of the same variable used in different branches, a micro-op is inserted to merge registers from the different paths. Third, the branch predictor operates at the batch (or warp) granularity, i.e., only one prediction is generated for all the threads in a batch. When updating the branch history, we apply a majority voting policy of branch results. For mispredicted threads, their instructions are flushed at the commit stage and the corresponding PCs and active mask are updated accordingly. Adding the majority voting circuitry before the branch prediction increases the branch execution latency and energy. We account for these overheads in our evaluation, detailed in Section II.

Control Flow Divergence Handling: To address control flow divergence, a hardware SIMT convergence optimizer is employed to serialize divergent paths. The optimizer relies on stack-less reconvergence with MinPC heuristic policy. In this scheme, each thread has its own Program Counter (PC) and Stack Pointer (SP), however, only one current PC (i.e., one path) is selected at a time. The selected PC is given to the basic block whose entry point has the lowest address. The MinPC heuristic relies on the assumption that reconvergence points are found at the lowest point of the code they dominate. For function calls, we assume MinSP policy such that we give priority to the deepest function call, or setting a convergence barrier at the instruction following the procedure call.

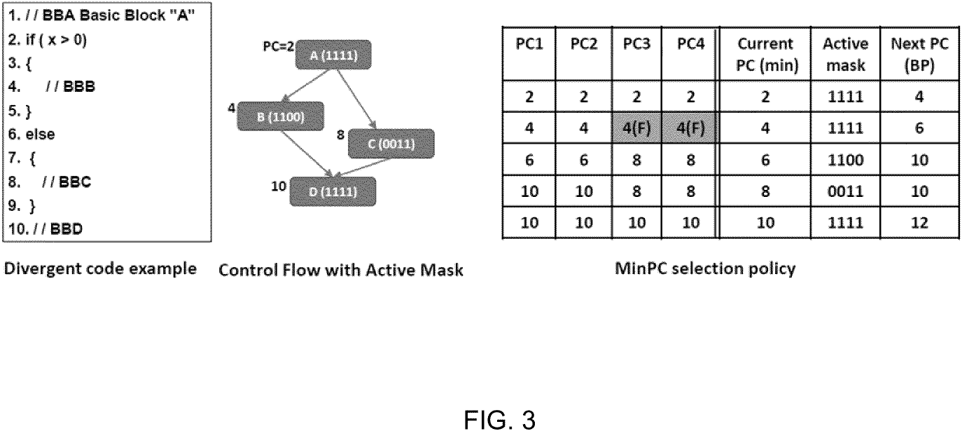

FIG. 3 illustrates an example of MinPC policy analysis and how the PC selection interacts with divergent control flow. When threads execute divergent control flows, the paths are serialized, and each path is associated with the current PC and corresponding active mask. The serialization overhead is minimized by intelligent batching techniques that minimize control flow divergence, which we describe in Section I-B1. The MinPC strategy has been found to achieve 100% accuracy to determine correct reconvergence points for GPGPU workloads and up to 94% for CPU SPECint workloads. Even in the rare cases where the policy misses the correct reconvergence points, it still reconvergnces not too far behind and achieves overall good SIMT control efficiency (Section I-B1). The stack-less reconvergence approach is transparent to the compiler and ISA, and can handle indirect-branch without the need for profiling or virtual ISA support. This is unlike the other stack-based approaches that are widely used in modern GPUs which require compiler-assisted static analysis to determine correct reconvergence points and ISA support to update the hardware stack and list all the targets of indirect branch.

Running threads in lock-step execution and serializing divergent paths can induce deadlock when programs employ inter-thread synchronization. There have been several proposals to alleviate the SIMT-induced deadlock issue on GPUs. Fundamentally, all the proposed solutions rely on multi-path execution to allow control flow paths not at the top of the SIMT stack to make forward progress. In the RPU, when an active thread’s PC has not been updated for k cycles and there are many atomic instructions are decoded within the k-cycle window (indication for spin locking by other selected threads), then the waiting thread is prioritized and we switch to the other path for t cycles. Otherwise, the default MinSP-PC is applied. MinSP-PC selection policy can increase the branch prediction latency, hindering pipeline utilization. To mitigate this issue, we can leverage techniques proposed for complex, multi-cycle branch history structures, such as hierarchical or ahead pipelining prediction.

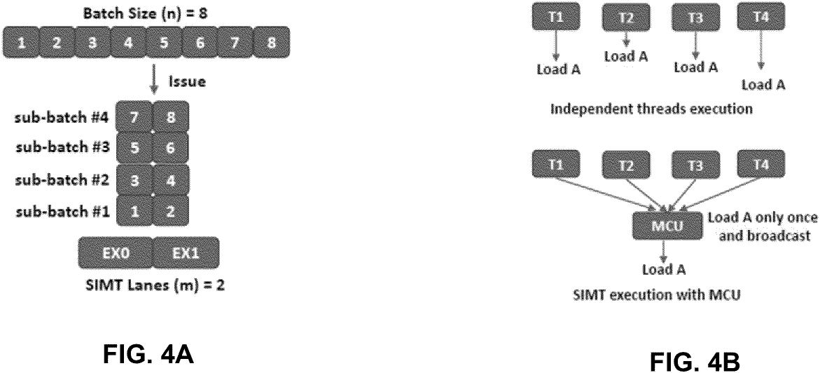

FIGS. 4A-B illustrates an example of sub-batch interleaving and memory coalescing using an MCU to improve latency hiding and memory throughput efficiency respectively.

Sub-batch Interleaving: Previous work show that data center workloads tend to exhibit low IPC per thread (a range of 0.5-2, the average is 1 out of 5), due to long memory latency at the back-end and instruction fetch misses at the front-end. To increase our execution unit utilization and ensure a reasonable backend execution area, we implement sub-batch interleaving as depicted in FIG. 4A. By decreasing the number of SIMT lanes (m) per execution unit to be a fraction of batch size (n), we issue threads over multiple cycles. Sub-batch interleaving along with OoO scheduling can hide nanosecond-scale latencies efficiently, increasing our IPC utilization. Another advantage of sub-batch interleaving is that we can skip issue slots of non-active threads to mitigate control divergence penalty and support smaller batches of execution. To hide longer microsecond-scale latencies, multiple batches can be interleaved via hardware batch scheduling in a coarse-grain, round-robin manner with zero-overhead context switching. Studying multi-batch scheduling to hide microsecond-scale latency is beyond the scope of this work.

Memory Coalescing: To improve memory efficiency, a low-latency memory coalescing unit (MCU) is placed before the load and store queues 5. As illustrated in FIG. 4B, the MCU is designed to coalesce memory accesses to the same cache line from threads in a single batch, making better use of cache throughput and avoiding cache access serialization. The MCU filters out accesses to shared inter request data structures that might exist in the heap or data segments. To balance the need for a low cache hit latency and avoiding divergent accesses serialization, the MCU only detects the two most common memory coalescing scenarios: when all threads access the same word, or when threads access consecutive words from the same cache line. This is unlike the complex sub-batch sharing in GPU data coalescing that increases memory access latency to detect more complex locality patterns.

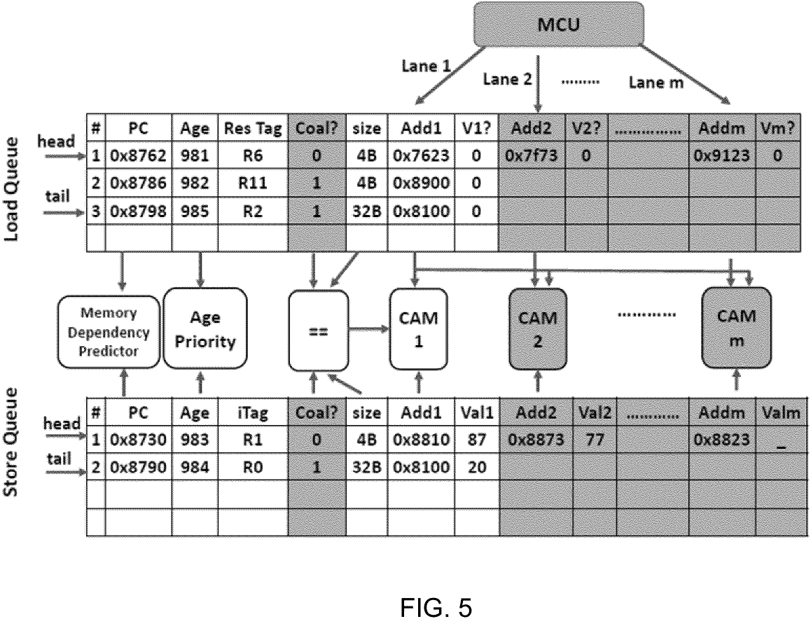

LD/ST Unit: FIG. 5 illustrates an example of a LD/ST unit. In the MCU, if neither simple pattern is detected, the number of accesses generated will equal the number of active SIMT lanes. All accesses from the same instruction will allocate one row in the load or store queue 6, sharing the same PC and age fields/logic, and thus amortizing the memory scheduling and dependence prediction overhead. The entries of the RPU’s LD/ST queues are expanded such that each row can contain as many addresses as there are SIMT lanes. This expansion is accounted for in Section II. Further, we assign an independent content-address memory (CAM) for each lane to account for in-parallel store-to-load forwarding. For coalesced accesses, only one slot in the entry (entry#0) is allocated and broadcasted for CAM comparisons. To save area, we do not preserve the loaded value in the load queue; instead, we write the return value to the register file directly and set the corresponding valid bit. Therefore, the load instruction is completed, and the tag is broadcasted when all the slots in the entry are valid and completed.

Cache and TLB: To serve the throughput needs of many threads, while achieving scalable area and energy consumption, the RPU uses a banked L1 cache. The load/store queues are connected to the L1 cache banks via a crossbar 7. To ensure TLB throughput can match the L1 throughput, each L1 data bank is associated with a TLB bank. Since the interleaving of data over cache banks is at a smaller granularity than the page size, TLB entries may be duplicated over multiple banks. This duplication overhead reduces the effective capacity of the DTLBs, but allows for high throughput translation on cache+TLB hits. As a result of the duplication, all TLB banks are checked on the per-entry TLB invalidation instructions. Sections I-B3 and I-B4 discuss how we alleviate contention to preserve intra-thread locality and achieve acceptable latency via batch size tuning and SIMR-aware memory allocation.

Weak Consistency Model: To exploit the fact that requests rarely communicate and exhibit low coherence, read-write sharing or locking, as well as extensive use of eventual consistency in data center, we design the memory system to be similar to a GPU, i.e., weak memory consistency with non-multi-copy-atomicity (NMCA). RPU implements a simple, relaxed coherence protocol with no-transient states or invalidation acknowledgments, similar to the ones proposed in HMG and QuickRelease. That is, cache coherence and memory ordering are only guaranteed at synchronization points (i.e., barriers, fences, acquire/release), and all atomic operations are moved to the shared L3 cache. Therefore, we no longer have core-to-core coherence communication, and thus we replace the commonly-used mesh network in CPUs with a higher-bisection-bandwidth, lower-latency core-to-memory crossbar 8. Further, NMCA permits threads on the same lane sharing the store queue and allows early forwarding of data, reducing the complexity of having separate store queue per thread. This relaxed memory model allows our design to scale the number of threads efficiently, improving thread density by an order of magnitude.

1) CPU vs GPU vs RPU: Table 2 lists the key architectural differences between CPUs, GPUs and our RPU. The RPU takes advantage of the latency-optimizations and programmability of the CPU while exploiting the SIMT efficiency and memory model scalability of the GPU. Finally, Table 3 summarizes a set of data center characteristics that create inefficiencies in CPU designs and how the RPU improves them.

TABLE 2

CPU vs GPU vs RPU architecture differences

| | | | | |
|---|---|---|---|---|
| Metric | CPU | GPU | | RPU |
| Core model | OoO | In-Order | | OoO |
| Freq | High | Moderate | | High |
| ISA | ARM/x86 | HSAIL/PTX | | ARM/x86 |
| Programming | General-Purpose | CUDA/OpenCL | | General-Purpose |
| System Calls | Yes | No | | Yes |
| Thread grain | Coarse grain | Fine grain | | Coarse grain |
| TLP per core | Low (1-8) | | Massive (2K) | Moderate (8-32) |
| Thread model | SMT | SIMT | | SIMT |
| Consistency | Variant | Weak+NMCA | | Weak+NMCA |
| Coherence | Complex | Relaxed Simple | | Relaxed Simple |
| Interconnect | Mesh | Crossbar | | Crossbar |

TABLE 3

CPU inefficiencies in the data center

| | |
|---|---|
| Data center characteristics & CPU inefficiency | RPU’s mitigation |
| Request similarity [37] & high frontend power consumption [11] | SIMT execution to amortize frontend overhead |
| Inter-request data sharing [25] | Memory coalescing and an increase in the number of threads sharing private caches |
| Low coherence/locks [24], [25] and eventual consistency [81] | Weak memory ordering, relaxed coherence with non-memory-copy-atomicity & higher bandwidth cote-to-memory interconnect |
| Low IPC due to frequent frontend stalls and memory latency [20], [23]-[26] | Multi-thread/sub-batch interleaving |
| DRAM & L3 BW are underutilized, data prefetchers are ineffective [21], [24], [25], [27] | High thread level parallelism (TLP) to fully utilize BW |
| Microservice/nanoservice have a smaller cache footprint [17] | High TLP and decrease L1&L2 cache capacity/thread |

2) An Examination of SMT vs SIMT Energy Efficiency: This subsection examines why the RPU’s SIMT execution is able to outperform MIMD SMT hardware for data center workloads. Equation 1 presents an analytical computation of the RPU’s energy efficiency (EE) gain over the CPU. In Equation 1, n is the RPU batch size, eff is average RPU SIMT efficiency, and r is the ratio of memory requests that exhibit inter-thread locality within a single SIMR batch. CPU energy is divided into frontend OoO overhead (including, fetch, decode, branch prediction and OoO control logic), execution (including, register reading/writing and instruction execution), memory system (including, private caches, interconnection and L3 cache), and static energies.

$$\begin{matrix}E E = \frac{C P {U}_{E n e r g y}}{R P {U}_{E n e r g y}} = \frac{E x e {c}_{E n e r g y} + M e {m}_{E n e r g y} + F E \_ O o {O}_{E n e r g y}}{E x e {c}_{E n e r g y} + \left(1 - r\right) M e {m}_{E n e r g y} + \frac{1}{n ∗ e f f} ∗} \\ \frac{+ S t a t i {c}_{E n e r g y}}{\left[r ∗ M e {m}_{E n e r g y} + F E \_ O o {O}_{E n e r g y} + S t a t i {c}_{E n e r g y}\right] + S I M {T}_{O v e r h e a d}}\end{matrix} \qquad \text{(1)}$$

In Equation 1, the RPU’s energy consumption in frontend and OoO overheads are amortized by running threads in lock step; hence the energy consumed for instruction fetch, decode, branch prediction, control logic and CAM tag accesses for register renaming, reservation station, register file control, and load/store queue are all consumed only once for all the threads in a single batch (see FIGS. 2 and 5). In scalar CPU designs, the front-end and OoO overheads have to be consumed for each thread. Even with SMT, the entire CPU pipeline is partitioned among the simultaneous threads. Threads on the same core are executed independently, which fails to exploit thread similarity and increases single thread latency.

Coalesced memory accesses are also amortized in the RPU by generating and sending only one access for a batch to the memory system. While private cache hits and MSHR merges can filter out some of these coalesced accesses in a SMT design, you have to guarantee that the simultaneous threads are launched and progress together to capture this inter-thread data locality, and you still pay the energy cost of multiple cache accesses. Furthermore, since SIMT can execute more threads/core given the same area constrains, the reach of its locality optimizations is wider.

The final metric SIMT execution amortizes is static energy. The RPU improves throughput/area and has a smaller SRAM budget/thread compared to an SMT core. It is worth mentioning that the RPU introduces an energy overhead (SIMT_{overhead} in Equation 1) for SIMT convergence optimizer, majority voting circuit, active mask propagation, MCUs, larger caches and multi-bank L1/L2 arbitration. However, at high SIMT efficiency, the energy savings from the amortized metrics greatly outweigh the SIMT management overhead.

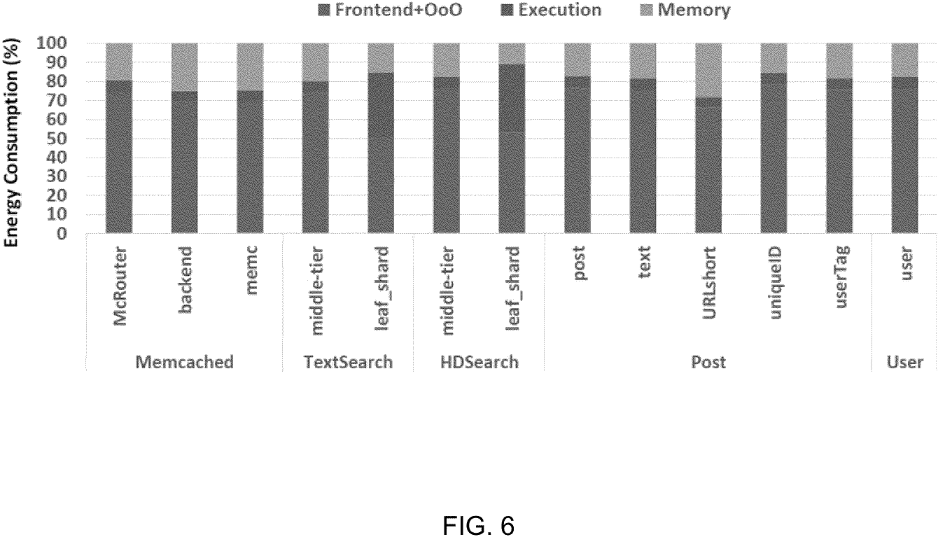

FIG. 6 illustrates energy consumption breakdown per pipeline stage of a studied microservices when running on CPU (Section II details our experimental methodology). Workloads consume a considerable amount of energy at the frontend and OoO stages, with an average of 73%. The HDSearch-leaf and TextSearch-leaf are the exceptions with 33% of energy consumed on frontend+OoO. These workloads contain fully SIMD vectorized functions; therefore, the backend consumes a large fraction of the energy. The memory subsystem consumes 20% of energy on average. By substituting these values in Equation 1 with the amortized components consume 50-90% of the total CPU energy, then an anticipated 2-10x energy efficiency gain can be achieved with the RPU if SIMT efficiency is high and accesses are frequently coalesced. This anticipated energy efficiency is aligned with previous work studied energy efficiency when vectorizing data-parallel workloads (PARSEC) on CPU hardware.

### B. SIMR Software Stack

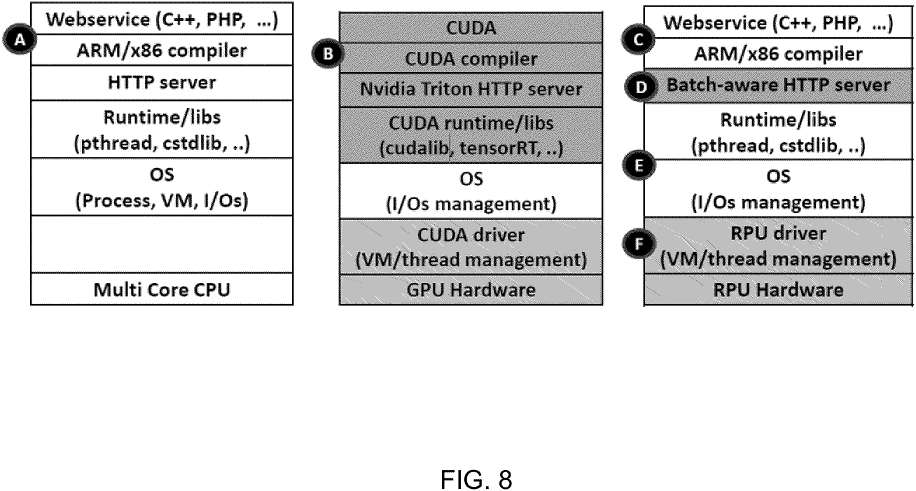

FIG. 8 compares the RPU’s software (SW) stack, to that of the CPU and GPU. GPU computing (B in FIG. 8) generally requires the programmer to use a specialized language, like CUDA, and (in the case of NVIDIA) uses a closed-source compiler, runtime, driver, and ISA. These all restrict programmer productivity. While GPUs have been successful for accelerating the DL inference, they are poorly suited for others with middling parallelism and tight deadlines.

Microservice developers typically use a variety of highlevel, open-source programming languages and libraries (A). For the RPU, we maintain the traditional CPU software stack (C, E), changing only the HTTP server, driver and memory management software. The RPU is lSA-compatible with the traditional CPU.

The role of our HTTP server (D) is to assign a new software thread to each incoming request. The SIMR-aware server groups requests in a batch based on each request’s Application Program Interface (API) similarity and argument size (see Section I-B1), then sends a service launch command for the batch to the RPU driver with pointers to the thread contexts of these requests.

The RPU driver (F) is responsible for runtime batch scheduling and virtual memory management. The driver overrides some of the OS system calls related to thread scheduling, context switching, and memory management, optimizing them for batched RPU execution. For example, context switching has to be done at the batch granularity (Section I-B5), and memory management is optimized to improve memory coalescing opportunities at runtime (Section I-B2).

To ensure efficient SIMT execution, the software stack’s primary goals are to: (1) minimize control flow divergence by predicting and batching requests control flow (Section I-B1), (2) reduce memory divergence and alleviate cache/memory contention (Sections I-B2, I-B3, I-B4) with batch tuning and SIMR-aware virtual memory mapping, and (3) alleviate network/storage divergence through systemwide batch splitting (Section I-B5).

1) SIMR-Aware Batching Serve: A key aspect to achieve high energy efficiency is to ensure batched threads follow the same control flow to minimize control divergence. To achieve this, we need to group requests that have similar characteristics. Thus, we employ two heuristic-based proof-of-concept batching techniques. First, we group requests based on API or RPC calls. Some microservices may provide more than one API, for example, memcached has set and get APls, post provides newPost and getPostByUser calls. Therefore, we batch requests that call the same procedure to ensure they will execute the same source code. Second, we group requests that have similar argument/query length. For example, when calling the Search microservice, requests that have long search query (i.e., more words) are grouped together as they will probably have more work to do than the smaller ones.

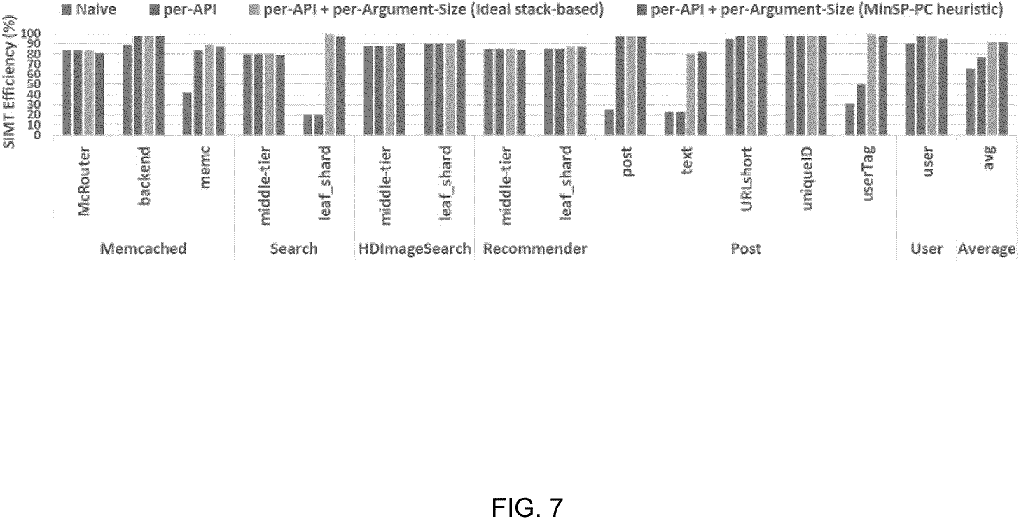

FIG. 7 illustrates SIMT efficiency (i.e., = #scalar-instructions / (#batch-instructions x batch-size)) for naive batching (based on arrival time) and an optimized per-API and per-argument batching. We demonstrate both the ideal reconvergence with stack-based IPDOM analysis and MinSP-PC heuristic policy. We assume a batch size of 32 requests for all microservices and we calculate the average over 75 batches (2400 requests). As shown in FIG. 7, batching per-API improves SIMT efficiency for many microservices, up to 2x improvement in memcached, and 4x in Post microservices. When taking into account per-argument length batching, the overall SIMT efficiency is further improved by 20% on average and up to 5x better on the Search-leaf and post-text microservices. In total, the stack-based analysis is able to achieve 92% SIMT efficiency. Interestingly, MinSP-PC is not far behind with an efficiency of 91% on average. In some microservices the heuristic even shows 1-2% higher efficiency due to eliminating the redundant execution of reconvergnce instructions in the stack-based approach.

It is worth mentioning that we achieve this SIMT efficiency while making the following assumptions. First, some of these microservices are not well optimized and employ coarse-grain locking which affects our control efficiency negatively due to critical section serialization and lock spinning. In practice, optimized data center workloads rely on fine-grain locking to ensure strong performance scaling on multi-core CPUs. In our experiments, if threads access different memory regions within a data structure, we assume that fine-grained locks are used for synchronization. We also assume that a high-throughput, concurrent memory manager is used for heap segment allocation rather than the C++ glibc allocator that uses a single shared mutex. Finally, the microservice HDSearch-midtier applies kd-tree traversal and contains data-dependent control flow in which one side of a branch contains much more expensive code than the others. To improve SIMT efficiency in such scenarios, we make use of speculative reconvergence to place the IPDOM synchronization point at the beginning of the expensive branch.

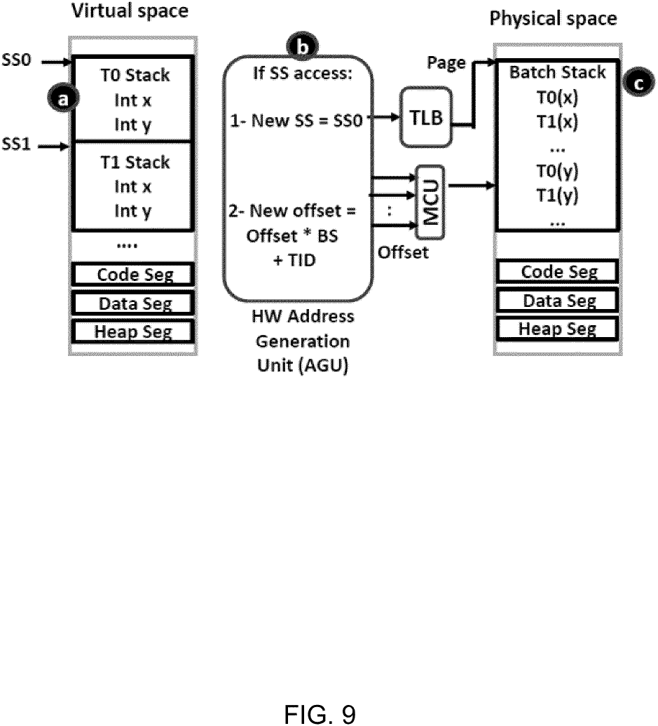

2) Stack Segment Coalescing: Similar to the local memory space in GPUs, FIG. 9 illustrates an example of how the RPU driver and TLB hardware allocate and map stack memory from different threads in the same batch to minimize memory divergence. The interleaving is static and transparent to the compiler and the programmer. When the runtime system calls mmap to allocate a new stack segment for a thread, we ensure that the stack segments for all the threads in a batch are contiguous (a in FIG. 9). In hardware, we detect accesses to stack addresses and apply an interleaved data mapping ( b ), such that stack segments from different threads are interleaved every 4 bytes in the physical address space ( c ). The RPU’s address generation unit overrides the stack base of all active threads with the stack base of thread 0, thus we only need one TLB translation per stack access. A hardware offset mapping uses the thread ID (TID) of the accessing thread as an index into the S0 space to determine where the value resides in physical memory. This hard mapping prevents threads from accessing other thread’s stack data, which is allowed in CPU programming. To alleviate this issue, we calculate the target stack segment TID of each access based on the access’ virtual segment address, i.e. TargetTID = (SS-SS0)/StackSize, exploiting the fact that stacks are allocated consecutively in the virtual space. If the accessing thread has permission to access the target thread’s stack (discussed further in Section IV-C), then the TargetTID is used, allowing inter-thread stack accesses. It is worth noting that GPU programming languages avoid this issue by making stack values thread-local.

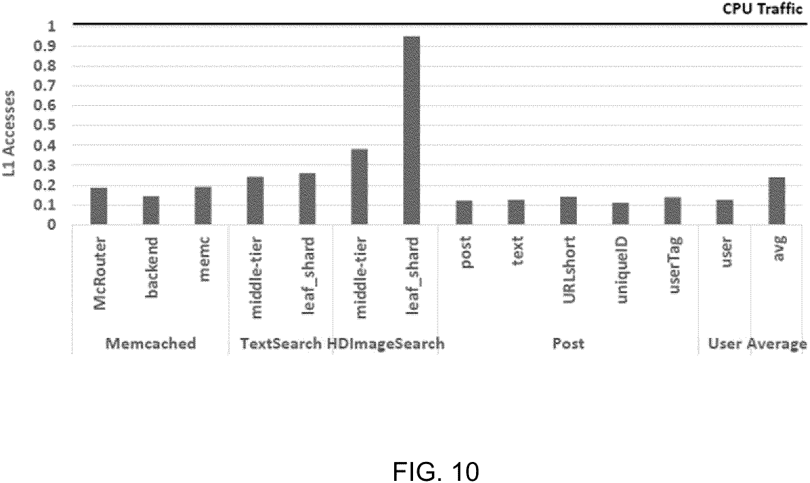

Coalescing Results: FIG. 10 illustrates an example of the effectiveness of stack interleaving and heap memory coalescing policies (previously described in Section l-A). FIG. 10 plots the total number of L1 accesses in the RPU, normalized to a MIMD CPU, when both are executing 640 threads. The RPU’s 32-thread batches generate on average 4x less accesses than the CPU. The causes of this traffic reduction are two-fold. First, many of our middle tier microservices contain significant stack segment accesses (up to 90% in the Post microservices) caused by frequent procedure/system calls, push/pop argument passing, and reading/writing local variables. Our stack segment interleaving technique coalesces all these accesses and generates less traffic compared to the CPU. For example, pushing an 8-byte address in each thread of a 32-thread batch onto the stack generates 8 accesses (8B x 32 threads / 32B cache lines); however, in the CPU, 32 accesses are generated.

Second, microservices typically share some global data structures and constant values in the heap and data segments respectively. In the RPU, accesses to this shared data are coalesced within the MCU and loaded once for all the threads in a batch, improving L1 data locality. While traffic reduction is significant in many cases, back-end data-intensive microservices, like HDSearch, still exhibit high traffic as each thread contains private data structures in the heap with little sharing, resulting in frequent divergent heap accesses.

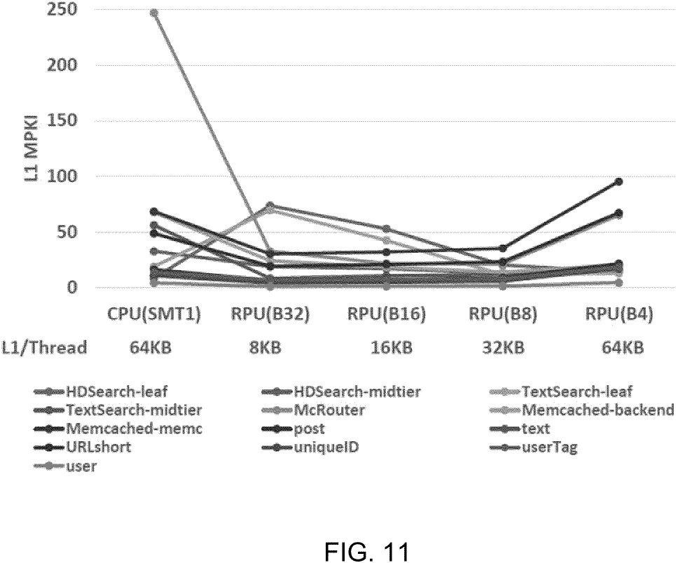

3) Batch Size Tuning and Memory Contention : Previous work shows that micro and nanoservices typically exhibit a low cache footprint per thread, as services are broken down into small procedures and read-after-write interprocedure locality is often transferred to the system network via RPC calls. To exploit this fact, we increase the number of threads per RPU core compared to traditional CPUs. FIG. 11 shows the L1 MPKI of a single threaded CPU with 64 KB of L1 cache and an RPU with different batch sizes (32, 16, 8, 4) and 256 KB of L1 cache. Interestingly, many of our microservices can run at a batch size of 32 threads and require only 8 KB/thread without thrashing the L1 cache. More importantly, for these microservices, the L1 MPKI is significantly improved compared to the CPU. This is because memory coalescing reduces the overall number of L1 accesses as well as the number of misses. As the batch size decreases, the coalescing efficiency is reduced.

On the other hand, some microservices, like HDsearchleaf and Textsearch-leaf, have high L1 MPKI compared at a batch size of 32. These are data-intensive services, exhibiting a larger intra-thread locality footprint due to divergent heap segment accesses, read-after-write temporary data and prefetch buffer to hide long memory latency. However, they show low MPKI when we throttle the batch size to 8 (see FIG. 7). We have similar observations for TLB and memory system contention when applying batch size tuning. Therefore, we run all our microservices at a batch size of 32, except for these data-intensive services, which are executed with a batch size of 8. Thanks to sub-batch interleaving, running at this smaller batch size does not affect our execution unit utilization. Regardless of batch size, the RPU hardware is designed with 8 SIMT lanes, as such, an 8-thread batch can fully utilize the pipeline, even though amortization suffers versus a 32-thread batch. It is worth noting that, after inspecting the HDsearch source code, we find that we can reduce the L1 cache footprint of the workload by eliminating some unnecessary data copies and employing function fusion (analogous to kernel/layer fusion in GPU and DL); however, we decided not to alter the program in our experiments.

Selecting the right batch size has many other factors, e.g. the request arrival rate and system configuration. As widely practiced by data center providers, an offline configuration can be applied to tune the batch size for a particular microservice. The time overhead to formulate a batch size of 8-32 requests is well tolerated by data center providers and matches those used in Google and Facebook’s batching mechanisms for deep learning inference.

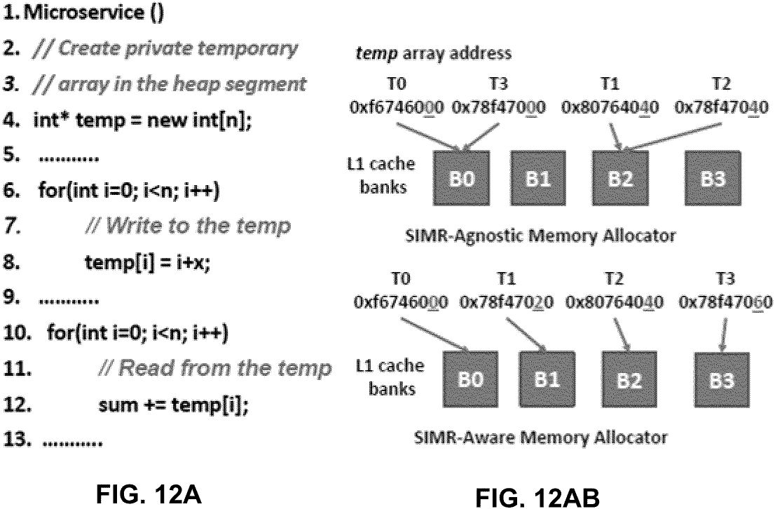

4) SIMR-Aware Memory Allocation : Divergent accesses to the heap have the potential to create bank conflicts in the RPU’s multi-bank L1 cache. FIG. 12A depicts a frequent code pattern in our microservices. The program dynamically allocates a thread-private temporary array on the heap (line#4), fills the array with intermediate results in a linear fashion (line#8), and reads from this array to process the data (line#12). The top section of FIG. 12B shows the behavior of the default C++ SIMR-agnostic CPU allocator. We assume virtually-indexed L1 cache as widely employed by CPU designs. Thus, the memory allocator may assign addresses to the temp array that result in significant bank conflicts. One solution for this is to change the address mapping of the heap segment to interleave elements accessed by parallel threads, similar to our stack segment interleaving. However, this type of interleaving is ill-suited for heap accesses, which are less structured than stack accesses. Another solution is to rely on hardware-based xoring hashing, however our experiments show that it is ineffective to alleviate bank conflicts.

To this end, we address this problem by proposing a new SIMR-aware memory allocator that the RPU driver can provide as an alternative and overrides the memory allocator used by the run-time library through LD PRELOAD Linux utility. Our proposed memory allocator, demonstrated in the bottom image of FIG. 12B, avoids data interleaving for the heap segment. Instead, the key idea is to take into account that data are already interleaved every n bytes over L1 banks (n=32B in our baseline). Therefore, if we ensure that the start address of every new memory allocation per thread follows the condition (start address%(n*tid) = 0), then accesses to the private data structure will be conflict-free for all consecutive data accesses, as shown in FIG. 12b. The overhead of this method is the unused few bytes at the start of each data allocation to ensure the alignment constraint (around 896 bytes for an 8-thread allocation). This memory fragmentation is amortized with large memory allocation sizes.

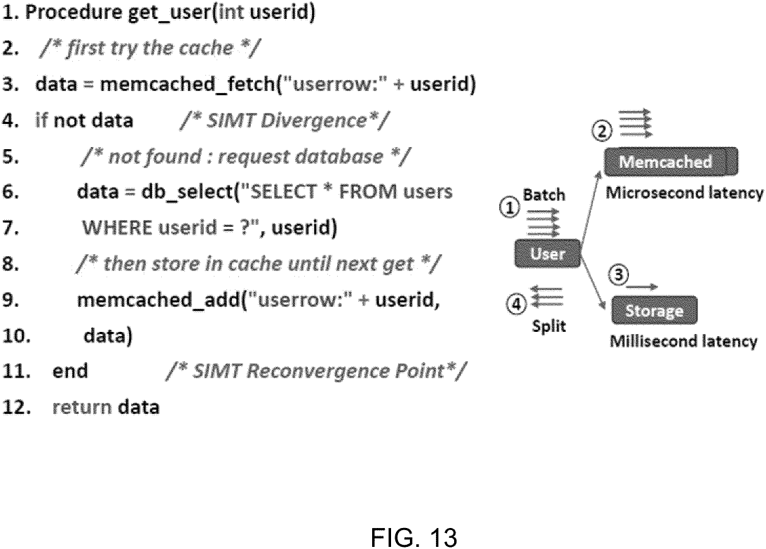

5) System-Level Batch Splitting : In the RPU, context switching is done at the batch granularity, either all threads in a batch are running or all the threads in the batch are switched out. When RPU threads are blocked due to an I/O event, the RPU driver groups the I/O received interrupts and wakes the all the threads in the same batch at the same time to handle their interrupts and continue lock-step execution. However, requests with the same batch can follow different control paths, in which one path may be longer than the other. For memory and nanosecond-scale latencies, the paths synchronize at the IPDOM reconvergence point. However, if one path contains significantly longer millisecond-scale latency (e.g., a request to storage or the network), this can hinder the threads on the other path, exaggerating the average latency. FIG. 13a illustrates a frequently-used design pattern in microservice development, in which we cache the back-end storage accesses in a fast in-DRAM key-value store, like memcached (line#3 in FIG. 13a). If the user request hits in the microsecond-scale latency memcached, the request returns immediately to the client (line#12); otherwise, it has to access the millisecond-scale storage, update the cache, and send the result back (lines#5- 10). If the hit requests have to wait for the misses at the reconvergence point (line#11), then the storage latency will dominate the total average latency.

To avoid this issue, we propose, a batch splitting technique, as depicted in FIG. 13b, in which we split the batch and allow multi-path execution for hit and miss requests. That is, the batch is subdivided into two batches, one for the hit requests to continue execution beyond reconvergence point ( 4 in FIG. 13b) and the other for blocked requests accessing the storage ( 3 ). The architecture state and call stack are copied and saved for the blocked requests. It is worth noting that, in cycle-level multipath execution on GPUs, divergent paths still ultimately converge and resources are not freed until all paths are complete. In SIMR batch splitting, the fast completing path can be allowed to continue, and finish execution, while the slower blocked path is context switched out, freeing up resources for other requests.

A hardware-based timeout or software-based hint can be used to determine the splitting decision. Although batch splitting reduces control efficiency, as the miss requests will continue execution alone, we can still batch these orphan requests at the storage microservice and formulate a new batch to be executed with a full SIMT active mask. We believe there is a wide space of future work to analyze the microservice graph for splittng and batching opportunities.

### II. Experimental Setup

Workloads: We study a microservice-based social graph network, similar to the one represented in the DeathStarBench suite. TextSearch, HDImageSearch, and McRouter are adopted from the µsuite benchmarks. We use the input data associated with the suite. The microservices use diverse libraries, including c++ stdlib, Intel MKL, OpenSSL, FLANN, Pthread, zlib, protobuf, gRPC and MLPack. The post and user microservices are adopted from the DeathStarBench workloads and social graph is from SAGA-Bench. The microservices have been updated to interact with each other via Google’s gRPC framework, and they are compiled with the -O3 option and SSE/AVX vectorization enabled. While the RPU can also execute other HPC/GPGPU applications that exhibit the SPMD pattern, like OpenMP and OpenCL, we only focus our study here on microservice workloads. Section IV-D discusses the use case of running GPGPU workloads on RPU in further details.

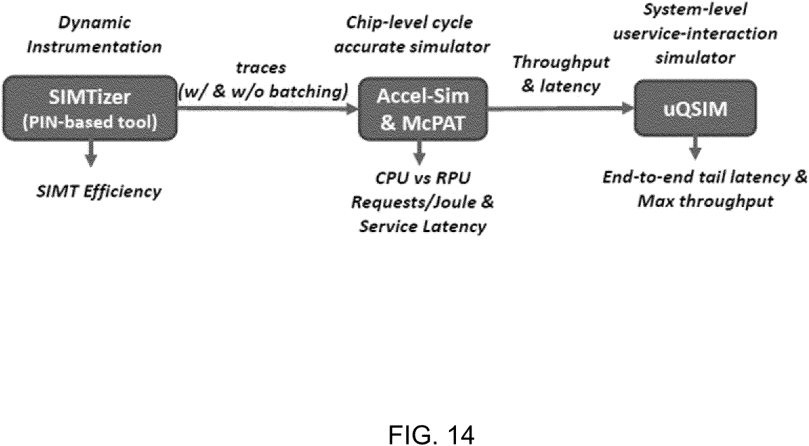

Simulation Setup: We analyze our RPU system over multiple stages and simulation tools. FIG. 14 shows an end-to-end experimental setup. First, we analyze the SIMT efficiency of our microservice with an in-house x86 PIN-based tool, named SIMTizer. The tool traces the dynamic control flow of CPU threads running in a batch with stack-based IPDOM reconvergence analysis, and calculates the associated active mask and overall SIMT efficiency. SIMTizer traces the whole SW stack, including user code, libraries, and frameworks. Due to the PIN’s userspace mode, we were not able to trace system calls; however, they only represent 20% of the microservices executed instructions, and we expect they should show high SIMT control efficiency.

We ensure both CPU and RPU have the same pipeline configuration, and frequency. For SMT8, we maintain the same number of total threads and memory resources/thread vs RPU (see the last four entries in Table 4). Cache latency is calculated based on CACTI v7.0. The multibank caches and MCU increase the L1/L2 hit latency from 3/12 cycles in the CPU to 8/20 cycles in the RPU. For other execution units, the ALU/Branch execution latency is increased to 4 cycles in the RPU to take into account the extra wiring and capacitance of adding more lanes and the majority voting circuit. We assume an idealistic cache coherence protocol for the CPU, with zero traffic overhead, in which atomics are executed as normal memory loads in private cache, whereas, in RPU, atomic instructions bypass private caches and execute at shared L3 cache.

TABLE 4

CPU vs RPU Simulated Configuration

| | | | |
|---|---|---|---|
| Metric | CPU | CPU SMT | RPU |
| Core Pipeline | 8-wide 256-entry OoO | 8-wide 256-entry OoO | 8-wide 256-entry OoO |
| ISA | x86-64 | x86-64 | x86-64 |
| Freq | 2.5 GHZ | 2.5 GHZ | 2.5 GHZ |
| #Core | 98 | 80 | 20 |
| Thread s/core | 1 | SMT-8 | SIMT-32 (1 batch) |
| Total Threads | 98 | 640 | 640 |
| #Lanes | 1 | 1 | 8 |
| Max IPC/core | 8 | 8 | 64 (issue x lanes) |
| ALU/Bra Exec Lat | 1-cycle | 1-cycle | 4-cycle |
| #Stages (ALU-load) | 9-12 | 9-12 | 14-18 |
| L1 Inst/core | 64 KB | 64 KB | 64 KB |
| Reg File (PRF)/core (scalar+ FP SIMD) | 6 KB | 48 KB | 192 KB |
| LSU (read/write) | 128/64 | 128/64 | 128/64 (8x wide) |
| L1 Cache | 64 KB, 8-way, 3-cycle, 1-bank 32B/cycle | 64 KB, 8-way, 3-cycle, 8-bank 256B/cycle | 256 KB, 8-way, 8-cycle, 8-bank 256B/cycle |
| L1 TLB | 48-entry | 64-entry | 256-entry, 8-bank (32-entry/bank) |
| L2 Cache | 512 KB, 8-way. 12-cycle, 1-bank | 512 KB, 8-way. 12-cycle, 2-bank | 2 MB, 8-way. 20-cycle, 2-bank |
| L3 Cache | 32 MB, 16-way | 32 MB, 16-way | 32 MB. 16-way |
| DRAM | 8x DDR5-3200, 200 CB/sec | 10x DDRS-7200, 576 GB/sec | 14x DDR5-7200, 576 GB/sec |
| Interconnect | 9x9 Mesh | 11×11 Mesh | 20x20 Crossbar |
| OoO entries/thread | 256, 8-wide | 32, 1-wide | 256,8-wide |
| L1 capacity/thread | 64 KB | 8 KB | 8 KB |
| TLB entries/thread | 48 | 8 | 8 |
| L1 B/cycle/thread | 32B/cycle | 32B/cycle | 32B/cycle |
| memeBW/thread | 2 GB/sec | 0.9 GB/sec | 0.9 GB/sec |

Third, to study batching effects on a large scale and system implications with context switching, queuing delay, and network/storage blocking, we harness uqsim, an accurate and scalable simulation for interactive microservices. The simulator is configured with our social graph network along with the latency and throughput obtained from Accel-Sim simulations to calculate systemwide end-to-end tail latency.

Energy&Area Model: We use McPAT, and some elements from GPUWattch to configure the CPU and RPU described in Table 4, to estimate per-component area, peak power and dynamic energy. For the RPU, we consider the additional components and augmentation required to support SIMT execution, as illustrated in FIG. 2. The majority voting circuitry is modeled as a CAM structure (32-way comparator) to count the taken and non-taken results and a reduction tree to calculate the most selected destination address. The SIMT optimizer is modeled as 2x reduction tree to calculate the minimum PC and SP, and a CAM structure to calculate the active mask. A 2x 32-way CAM structure is used to model the memory coalescing units. The RAT, ROBs, and uop buffers are extended to include the 4-byte active mask and its associated logic. To support SMT-8 in the CPU, 14% area and power increase per core is required (not shown in the table for brevity).

Table 5 shows the calculated area and peak power for the RPU and single-threaded CPU at 7-nm technology. From analyzing the table results, we can make the following observations. First, the CPU’s frontend+OoO area and power overhead are roughly 40% and 50% respectively, which are aligned with modern CPU designs. The table shows that the RPU core is 6.3x larger and consumes 4.5x more peak power than the CPU core; however, the RPU core support 32x more threads. Second, in the RPU core, most of the area is consumed on the register file and execution units, 68% of the area vs. 35% in the CPU. The additional overhead of the RPU-only structures consume 11.8% of the RPU core. Most of this overhead comes from the 8×8 crossbar that connects the L1 banks to the LD/ST queues. Third, the dynamic energy per L1 access and L2 access in RPU is higher by a factor of 1.72x and 1.82x respectively than in CPU, due to the larger cache size, L1-Xbar and MCU. However, the generated traffic reduction and other energy savings in the front-end will offset this energy increase as detailed in the next section.

TABLE 5

Per-component area and peak power estimates

| Component | Area | | | | Peak Power | | | |
|---|---|---|---|---|---|---|---|---|
| | CPU | | RPU | | CPU | | RPU | |
| | mm² | % Core | mm² | % Core | Watt | % Core | Watt | % Core |
| Fetch&Decode | 0.27 | 24.3 | 0.3 | 4.3 | 0.39 | 15.6 | 0.4 | 3.6 |
| Branch Prediction | 0.01 | 0.9 | 0.01 | 0.1 | 0.02 | 0.8 | 0.02 | 0.2 |
| OoO | 0.11 | 9.9 | 0.17 | 2.4 | 0.85 | 34 | 1.45 | 12.9 |
| Register File | 0.14 | 12.6 | 2.52 | 35.8 | 0.49 | 19.6 | 4.26 | 38 |
| Execution Units | 0.25 | 22.5 | 2.31 | 32.8 | 0.34 | 13.6 | 2.51 | 22.4 |
| Load/Store Unit | 0.07 | 6.3 | 0.34 | 4.8 | 0.13 | 5.2 | 0.41 | 3.7 |
| L1 Cache | 0.04 | 3.6 | 0.22 | 3.1 | 0.09 | 3.6 | 0.2 | 1.8 |
| TLB | 0.02 | 1.8 | 0.08 | 1.1 | 0.06 | 2.4 | 0.4 | 3.6 |
| L2 Cache | 0.2 | 18 | 0.71 | 10.1 | 0.13 | 5.2 | 0.24 | 2.1 |
| Majority Voting | 0 | 0 | 0.02 | 0.3 | 0 | 0 | 0.03 | 0.3 |
| SIMT Optimizer | 0 | 0 | 0.03 | 0.4 | 0 | 0 | 0.05 | 0.4 |
| MCU | 0 | 0 | 0.02 | 0.3 | 0 | 0 | 0.01 | 0.1 |
| L1-Xbar | 0 | 0 | 0.31 | 4.4 | 0 | 0 | 1.23 | 11 |
| Total-1core | 1.11 | | 7.04 | | 2.5 | | 11.21 | |
| | mm² | % Chip | mm² | % Chip | Watt | % Chip | Watt | % Chip |
| Total-Allcores | 108.8 | 77.2 | 140.8 | 81 | 245 | 72.5 | 224.2 | 73.7 |
| L3 Cache | 7.82 | 5.5 | 7.82 | 4.5 | 0.75 | 0.2 | 0.75 | 0.2 |
| NoC | 9.78 | 6.9 | 1.72 | 1 | 36.52 | 10.8 | 7.02 | 2.3 |
| Memory Ctrl | 14.64 | 10.4 | 23.59 | 13.6 | 6.85 | 2 | 19.27 | 6.3 |
| Static Power | | | | | 49 | 14.5 | 53 | 17.4 |
| Total Chip | 141 | | 173.9 | | 338.1 | | 304.2 | |

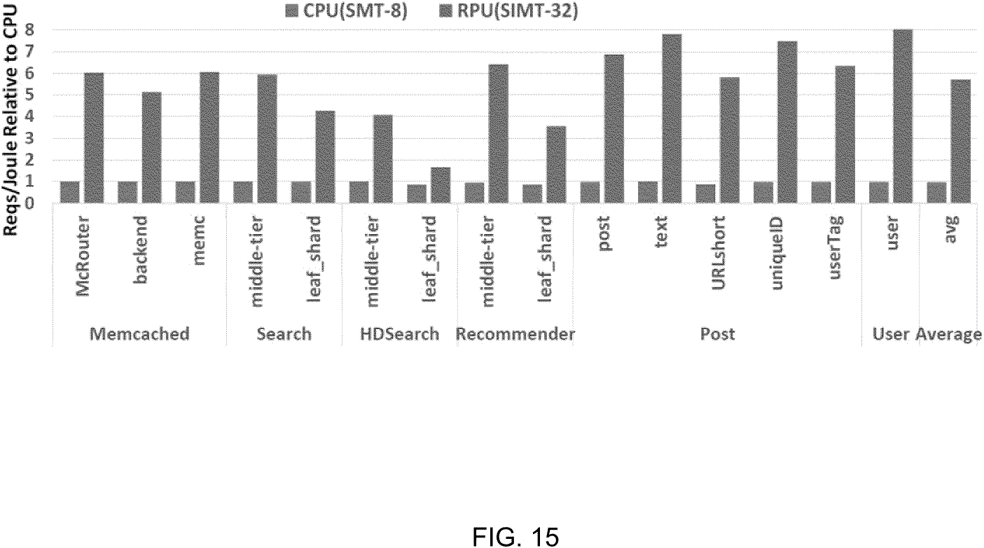

In Section III, we use the per-access energy numbers generated from our McPAT analysis with the simulation results generated by Accel-Sim to compute the runtime energy efficiency of each workload (FIG. 15).

### III. Experimental Results

### A. Chip-Level Results

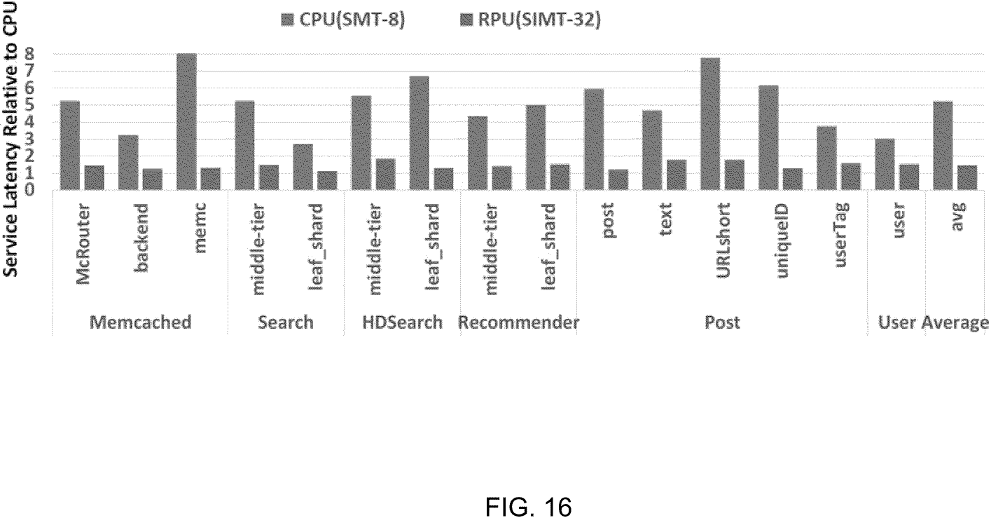

FIG. 15 and FIG. 16 show energy efficiency (Requests/Joule) and service latency of RPU and CPUSMTS normalized to single threaded CPU. All the hardware executes the same number of requests (2400). On average, the RPU can achieve 5.6x higher energy efficiency compared to CPU, while still coming within 1.35x of its service latency, with the worst service latency of 1.7x at HDSearchmidtier. Overall, the RPU’s service latency remains under the 2x higher latency limit defined by data center providers. The main causes of RPU’s energyefficiency are: (1) reducing the number of issued instructions by a factor of 30x, amortizing the frontend and OoO dynamic energy overhead that accounted for up to 70% in the scalar heavily-integer microservices, (2) generating 4x less traffic on average, therefore decreasing the memory energy consumption, and (3) running 6x more requests at almost the same service latency vs. the CPU, and thus amortizing the static energy. The HDSearch-leaf and TextSearchleaf microservices exhibit less energy-efficiency than the average. These workloads run at a smaller batch size, and the frontend+OoO only accounts for 33% of the CPU’s energy.

On the other hand, CPU-SMT8 only improves energy efficiency by 5% at a 5x higher service latency cost. This is because the number of issued instructions and the generated accesses are the same as in single threaded CPU. Further, SMT8 partitions the frontend resources per thread and causes cache serialization of stack segment accesses and shared heap variables, hindering service latency, whereas RPU avoids all these issues through SIMT execution.

The main causes of our 1.35x higher service latency in the RPU are three-fold. First, the control SIMT efficiency of some microservices like text and Textsearch is below 90% (see FIG. 7) in which the RPU serializes the divergent paths and increases service latency. Second, when CPU threads run consecutively, they prefetch some shared data to the L1 cache for the incoming threads running on the same core. In the RPU, many threads are run in parallel and incur these compulsory misses at the same time. Third, the L1 access latency of the RPU is longer (3 vs 8 cycles) as a result of a larger L1 cache size, the MCU and multi-bank arbitration.

1) Sensitivity Analysis: We evaluate RPU’s sensitivity to a number of system parameters:
Sub-batch interleaving: In the CPU, IPC per thread is limited, with an average IPC of 1, similar to those reported in data center studies. In the RPU, and thanks to sub-batch interleaving, we are able to improve our IPC utilization up to 4x by issuing threads over multiple cycles to the SIMT lanes. Although we reduced the number of SIMT lanes by 4x with sub-batch interleaving (i.e., from 32 to 8 lanes), we only noticed 2% performance loss on average compared to full width SIMT lanes
Moving atomics to L3: We did not notice slow down from moving atomics to L3 cache in the RPU as our microservices exhibit low atomic/locks per instructions. • SIMR-aware heap allocation: Our SIMR-aware heap segment improves the L1 cache throughput for frequent divergent heap segments in HDSearch, where a 1.8x higher throughput was achieved versus the SIMRagnostic heap allocations.
Majority voting: Majority voting optimizes the branch prediction for the common control flow (92% of the time threads traverse the same control flow). Still, the 8% control divergence causes some threads to have different predictions than they would with a per-thread prediction (i.e., as in CPUs). Since we predict next PC per entire batch, we will always have misprediction for the divergent threads of the other path. Majority voting mitigates the flushes caused by these inevitable branch mispredictions by optimizing for the common control flow, and thus improving overall energy efficiency. However, the majority voting policy has little impact on performance, as in case of divergence, both paths are visited anyways, and thus the branch predictor is always correct.

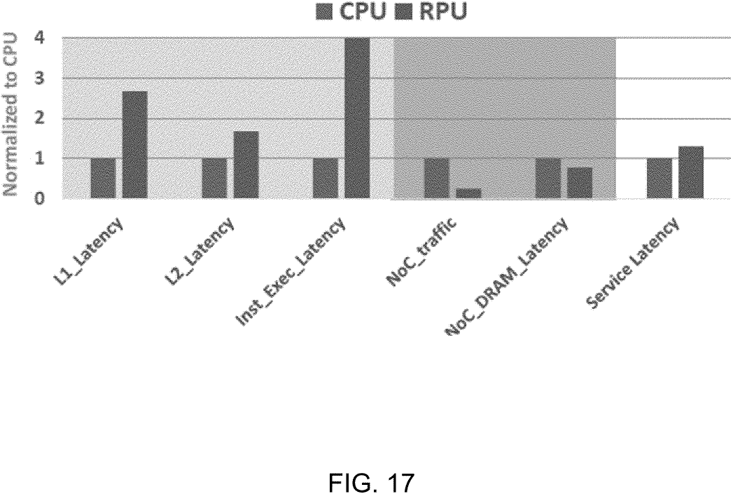

2) Service Latency Analysis: Despite our higher L1 access (2.3x), ALU and branch execution latency (4x), and control divergence (8%), some microservices are still able to achieve service latency close to the CPU, and on average only 1.35x higher latency. This is because memory coalescing has reduced the on-chip memory traffic, alleviating contention and minimizing the memory latency. FIG. 17 depicts several metrics that explain the relatively little increase in service latency for the RPU. The average network on chip (NoC) and DARM latency has been reduced by 1.33x because 4x less traffic is generated. The RPU’s memory coalescing and single-hop crossbar interconnect both combine to offset the latency increases in instructions and cache hits.

3) GPU Performance: We also run our simulation experiments on an Ampere-like GPU model with the same software optimization as the RPU (e.g., stack memory coalescing and batching) and assuming that the GPU supports the same CPU’s ISA and system calls. For the sake of brevity, we did not plot the per-app results in the figures. On average, the GPU achieves 28x higher energy efficiency than the CPU but at 79x higher latency. This high latency is unacceptable for QoS-sensitive data center applications. These results are expected and aligned with previous work studied server workloads on GPUs. The lower clock frequency, lack of OoO and speculative execution contribute to GPU’s higher service latency.

### B. System-Level Results

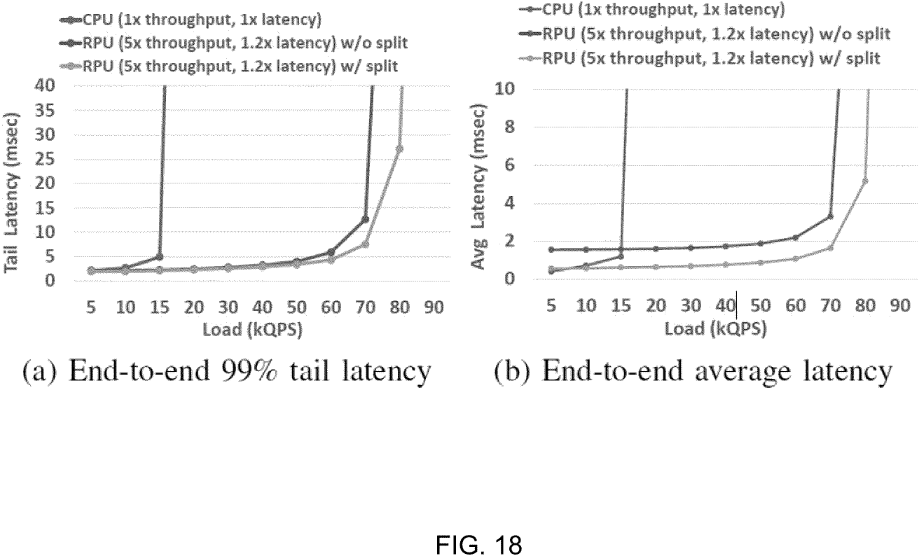

FIG. 18 shows the system-level, end-to-end 99% tail and average latency for CPU-based system and RPU-based system with and without our batch splitting technique described in Section I-B5. We scale the QPS load until reaching the highest maximum throughput at acceptable QoS and the system saturates.

We configure uqsim with the endto- end User microservice scenario passing from Web Server to User to McRouter to Memcached and Storage. We simulate three CPU server machines with 40 cores, where each microservice runs on its own server node. We assume a 90% hit rate of Memcached with 100, 20, 25, 1000 and 60 microseconds latency for User, McRouter, Memcached, Storage and network respectively. In the RPU configuration, we replace the CPU servers with RPU machines consuming the same power budget, i.e. assuming 5.2x higher Requests/Joule and 1.2x higher latency as were obtained from chip-level experiments for these services. Request batching is employed for memcached in the CPU configuration for epoll system call to reduce network processing, as is the common practice in data centers. To focus our study on processing throughput, we assumed unlimited storage bandwidth for both CPU and RPU configurations.

From analyzing the end-to-end results in FIG. 18, we can make the following observations. First, the RPU (with batch split) can achieve 5x higher request throughput per Joule compared to the CPU with almost the same tail and average latency. Second, the batching formulation time is amortized and incurs negligible overhead at both low and high traffic load. This is due to the fact that CPU system employs batching already for memcached. Third, without batch splitting on millisecond-scale storage accesses, the RPU exhibits higher average latency than the CPU, as blocked threads are waiting on a reconvergence point for the others that access the storage. However, RPU without batch splitting can still attain an acceptable tail latency. Although tail latency is more important than average latency for QoS measurements, the batch splitting technique can be beneficial to ensure predictable responsive time when unpredictable high latency episodes occur in large online services.

### IV. Discussion

### A. RPU vs CPU’s SIMD

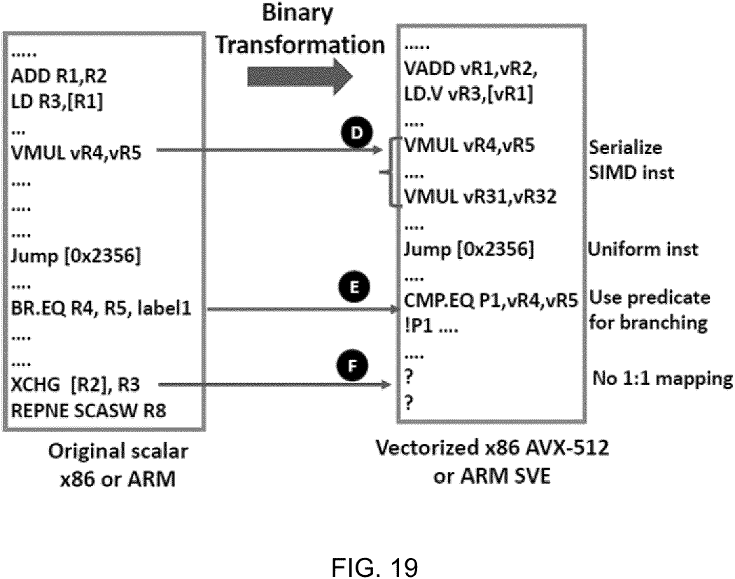

A possible alternative to the RPU would be recompile scalar CPU binaries for execution on the CPU’s existing SIMD units, e.g., x86 AVX or ARM SVE. Each request could be mapped to a SIMD lane, amortizing the front-end overhead, leveraging the latency optimizations of the CPU pipeline, and executing uniform instruction on the scalar units. Such a transformation could be done using a SPMD-on-SIMD compiler, like Intel ISPC, or at the binary-level, as depicted in FIG. 19. However, this solution has three primary shortcomings. First, it requires a complete recompilation of the microservice code, libraries, and OS system calls. Second, SIMD units on contemporary CPUs are designed to accelerate computationally-dense inner loops. The memory system and vector ISA are not optimized for the branch- and memory heavy microservices we focus on in the RPU. As a result, energy-efficiency and service latency will be negatively affected. For instance, we need to serialize existing SIMD instructions in the scalar binary (D in FIG. 19), predicate computation that cannot take advantage of branch prediction (E), and the fact that there are 2-3x more scalar units than SIMD units on existing CPUs, which will go unused if the code could be fully vectorized. Finally, many existing scalar instructions lack a 1:1 mapping with any vector instruction ( F ), e.g., complex string manipulation, atomic and OS operations. Based on a manual investigation in x86 ISA, there are 129 AVX instructions, and 463 scalar instructions, thus only a maximum of 27% of the scalar instructions are represented in the vector ISA.

### B. Multi-Threaded vs Multi-Process Services

Our proposed SIMR system focuses on multi-threaded services, which are widely used in data centers. However, the rise of serverless computing has made multiprocess microservices more common. In multiprocess services, the separate virtual address spaces can cause both control flow and memory divergence, even if the processes use the same executable and read the same data, which also causes cache-contention issues on contemporary CPUs. We believe that with user-orchestrated interprocess data sharing and some modifications to the RPU’s virtual memory; these effects can be mitigated. However, since the contemporary services we study are all multi-threaded, we leave such a study as future work.

### C. Security Implications

The grouping of concurrent requests for SIMT execution may enable new vulnerabilities. For instance, a malicious user may generate a very long query that could affect the QoS of other short requests or leak control information. Such attacks can be mitigated in our input size-aware batching software by detecting and isolating maliciously long requests, as described in Section I-B1. Another security vulnerability is the potential for parallel threads to access each other’s stack data (exploiting the fact that threads’ stack data are adjacent in the physical space). However, as described in Section I-B2, the RPU’s address generation unit is able to identify inter-thread stack accesses and throw an exception if such sharing is not permitted.

### D. GPGPU Workloads on RPU

RPU can also execute other HPC, GPGPU, and DL applications that exhibit the SPMD pattern, written in OpenMP, OpenCL, or CUDA. Multi-threaded vectorized workloads can run seamlessly on RPU with the only need to change the launched threads to be equal to RPU threads to fully utilize the core resources. GPUs are 2-5x more energy efficient than CPUs, thanks to their simpler In-Order pipeline and software-managed caches. However, this comes at the cost of easy-to-program. Developers need to rewrite the code in GPGPU programming language and make a heroic effort to get the most out of GPU’s compute efficiency. Recently, and to achieve high efficiency in the lack of HW-support OoO scheduling, Nvidia has written its back-end libraries in hand-tuned machine assembly to improve instruction scheduling and proposed complex asynchronous programming APIs to hide memory latency via prefetching. In CPUs, the HW-support OoO with a large instruction window relieves this burden from the programmers.

The RPU can seamlessly execute other HPC, GPGPU, and DL applications that exhibit the SPMD pattern, written in OpenMP, OpenCL, or CUDA. GPUs are 2-5x more energy efficient than CPUs [130]-[133], thanks to their simpler in-order pipeline, lower frequency, and software-managed caches. However, this energy efficiency comes at the cost of easy programmability. Developers need to rewrite their code in a GPGPU programming language and make a heroic effort to get the most out of the GPU’s compute efficiency. Recently, Nvidia has written its back-end libraries in hand-tuned machine assembly to improve instruction scheduling and has proposed complex asynchronous programming APIs to hide memory latency via prefetching. Such optimizations are likely necessary due to the lack of OoO processing. In CPUs, the hardware supports OoO scheduling with a large instruction window, which removes these performance burdens from the programmers. Furthermore, CPU programming supports system calls naturally and does not require CPU-GPU memory copies.

We believe that the RPU takes the best of both worlds. It can execute GPGPU workloads with the same easy-to-program interface as CPUs while providing energy efficiency comparable to a GPU. CPUs typically contain 1-2x 256-bit (assuming Intel AVX) SIMD engines per core to amortize the frontend overhead. In the RPU, 8x lanes running in lock step, each with a dedicated 256-bit SIMD engine, can provide a wider 2048-bit SIMD unit per core, amortizing the frontend overhead even further and reducing the energy efficiency gap with the GPU. GPUs will likely remain the most energy efficient for GPGPU workloads, but we believe RPUs will not be far behind.

### E. RPU vs GPU Terminology

RPU and GPU are both SIMT-based hardware. However, in this paper, we have used different hardware terminology. Table 6 compares Nvidia’s GPU and our RPU terminology.

TABLE 6

GPU vs RPU Terminology

| | |
|---|---|
| GPU | RPU |
| Grid/Thread Block (1/2/3-dim) | SW Batch (1-dim) |
| Warp | HW Batch |
| Thread | Thread/Request |
| Kernel | Service |
| GPU Core / Streaming MultiProcessor | RPU Core / Streaming MultiRequest |
| Warp Scheduler | Batch Scheduler |
| SIMT | SIMR |
| CUDA Core | Execution Lane |

### V. Conclusion

Data center computing is experiencing an energy efficiency crisis. Aggressive OoO cores are necessary to meet tight deadlines but waste energy However, modern productive software has inadvertently produced a solution hardware can exploit: the microservice. By subdividing monolithic services into small pieces and executing many instances of the same microservice concurrently on the same node, parallel threads execute similar instruction controlflow and access similar data. We exploit this fact to propose our Single Instruction Multiple Request (SIMR) processing system, comprised of a novel Request Processing Unit (RPU) and an accompanying SIMR-aware software system, improving energy-efficiency by 5.6x, while increasing single thread latency by only 1.35x. The RPU adds Single Instruction Multiple Thread (SIMT) hardware to a contemporary OoO CPU core, maintaining single threaded latency close to that of the CPU. As long as SIMT efficiency remains high, all the OoO structures are accessed only once for a group of threads, and aggregation in the memory system reduces accesses. Complimenting the RPU, our SIMR-aware software system handles the unique challenges microservice + SIMT computing by intelligently forming/splitting batches and managing memory allocation. Across 13 microservices, our SIMR processing system achieves 5.6x higher Requests/Joule, while only increasing single thread latency by 1.35x. We believe the combination of OoO and SIMT execution opens a series of new directions in the data center design space, and presents a viable option to scale on-chip thread count in the twilight of Moore’s Law.

To clarify the use of and to hereby provide notice to the public, the phrases “at least one of <A>, <B>, ... and <N>” or “at least one of <A>, <B>, ... <N>, or combinations thereof” or “<A>, <B>, ... and/or <N>” are defined by the Applicant in the broadest sense, superseding any other implied definitions hereinbefore or hereinafter unless expressly asserted by the Applicant to the contrary, to mean one or more elements selected from the group comprising A, B, ... and N. In other words, the phrases mean any combination of one or more of the elements A, B, ... or N including any one element alone or the one element in combination with one or more of the other elements which may also include, in combination, additional elements not listed.

A second action may be said to be “in response to” a first action independent of whether the second action results directly or indirectly from the first action. The second action may occur at a substantially later time than the first action and still be in response to the first action. Similarly, the second action may be said to be in response to the first action even if intervening actions take place between the first action and the second action, and even if one or more of the intervening actions directly cause the second action to be performed. For example, a second action may be in response to a first action if the first action sets a flag and a third action later initiates the second action whenever the flag is set.

While various embodiments have been described, it will be apparent to those of ordinary skill in the art that many more embodiments and implementations are possible. Accordingly, the embodiments described herein are examples, not the only possible embodiments and implementations.

What is claimed is:

1. A system, comprising:
a central processing unit (CPU) having a Simultaneous Multi-Threading (SMT) thread/execution model; and
a request processing unit (RPU) having an Out-of-Order Single Instruction Multiple Thread (SIMT) execution model,
wherein the CPU is configured to:
receive a plurality of requests;
group a portion of the requests in a batch;
cause the RPU to execute instructions corresponding to each request in the batch, and
wherein the RPU is configured to:
execute, with a plurality of threads, the instructions corresponding to the batch of requests in lockstep.

2. The system of claim 1, wherein the CPU and RPU are configured to execute instructions of a same instruction set architecture.

3. The system of claim 1, wherein to group a portion of the requests in the batch, the CPU is further configured to:
group the requests in response to the requests invoking a same procedure.

4. The system of claim 1, wherein to group a portion of the requests in the batch, the CPU is further configured to:
group the requests based on the number of arguments in the requests, respectively.

5. The system of claim 1, wherein the request is received at a data center over a communications network.

6. The system of claim 1, wherein the request is received according to a communications protocol.

7. The system of claim 6, wherein the communications protocol is Hypertext Transfer Protocol (HTTP) or Remote Procedure Call (RPC).

8. The system of claim 1, wherein the CPU is further configured to
assign a warp of threads to the requests of the batch, wherein each thread corresponds to a request.

9. The system of claim 7, wherein the CPU is further configured to:
coalesce stack segments of the threads in the physical address space to minimize memory divergence.

10. The system of claim 7, wherein the RPU is further configured to:
optimize control flow reconvergence at Immediate Post-Dominator (IPDOM) points;
wherein the RPU is further configured to:
execute the warp of threads according to the control flow.

11. The system of claim 10, wherein the control flow comprises active masks, wherein the RPU is configured to control which threads from the warp of threads are active during serialized execution of the instructions based on the active masks.

12. The system of claim 1, wherein the CPU and RPU are on the same chip.

13. The system of claim 1, wherein the CPU and RPU are on different chips.

14. The system of claim 13, wherein the CPU and RPU communicate via Peripheral Component Interconnect Express (PCIe).

15. The system of claim 1, wherein the CPU can split the batch and allow multi-path execution for requests having significantly longer millisecond scale latency.

16. An integrated circuit, comprising:
a central processing unit (CPU) core having a Simultaneous Multi-Threading (SMT) thread/execution model; and
a request processing unit (RPU) core having an Out-of-Order Single Instruction Multiple Thread (SIMT) execution model,
wherein the CPU is configured to:
receive a plurality of requests;
group a portion of the requests in a batch;
cause the RPU to execute instructions corresponding to each request in the batch, and
wherein the RPU is configured to:
execute, with a plurality of threads, the instructions corresponding to the batch of requests in lockstep.

17. A method, comprising
receiving a plurality of requests via a network communication protocol;
grouping, with a central processing unit (CPU), a portion of the requests in a batch based on at least one of:
the requests invoking a same procedure, and
the number of arguments in the requests; and
executing, with a remote processing unit (RPU) the instructions corresponding to each request in a batch in lockstep, the RPU supporting the same instruction set architecture as the CPU.

18. The method of claim 17, wherein the network communications protocol is Hypertext Transfer Protocol (HTTP) or Remote Procedure Call (RPC).

19. The method of claim 17, further comprising:
assigning a warp of threads to the requests of the batch, wherein each thread corresponds to a request.

20. The method of claim 17, further comprising:
coalescing stack segments of the threads in a physical address space to minimize memory divergence.

21. The method of claim 17, further comprising
optimizing, with the CPU, control flow reconvergence at Immediate Post-Dominator (IPDOM) points; and
executing, with the RPU, the warp of threads according to the control flow.
